(19) United States
(12) Patent Application Publication
(10) Pub. No.: US 2013/0054373 A1
(43) Pub. Date: Feb. 28, 2013

(54) PRINTER CONSUMABLES RECOMMENDATIONS

(71) Applicants: Maria Del Carmen Tate, Santee, CA (US); Katherine Grubstein, San Diego, CA (US); Dario Giovanni Miticocchio, San Diego, CA (US); Ryan Lane Wilday, Escondido, CA (US)

(72) Inventors: Maria Del Carmen Tate, Santee, CA (US); Katherine Grubstein, San Diego, CA (US); Dario Giovanni Miticocchio, San Diego, CA (US); Ryan Lane Wilday, Escondido, CA (US)

(21) Appl. No.: 13/222,946

(22) Filed: Aug. 31, 2011

(51) Int. Cl. G06Q 30/00; G06Q 20/00

(52) U.S. Cl. 705/14.65

(57) ABSTRACT

In one embodiment, first data is received that associates a user of a network-connected computing device configured to vend new printer consumables with a network-connected printer. Second data is received regarding printer consumable usage at the printer. A recommendation of a new consumable for use at the printer is generated for display at the device. The recommendation is generated in consideration of the first and second data. Third data, that payment is received for the new consumable, is received. A message is sent authorizing dispensing of the new consumable at the device.

### BACKGROUND

A consumer that desires to purchase an inkjet cartridge or other printer consumable to replace an empty printer consumable frequently makes such a purchase in person at a retail facility.

### BRIEF DESCRIPTION OF THE DRAWINGS

The accompanying drawings illustrate various embodiments and are a part of the specification. The illustrated embodiments are examples and do not limit the scope of the claims. Throughout the drawings, identical reference numbers designate similar, but not necessarily identical elements.

FIG. 1 is a block diagram illustrating a system according to various embodiments.

FIG. 2 is a block diagram illustrating a system according to various embodiments.

FIG. 3 is an example of user interaction with a computing device configured to vend new printer consumables.

FIG. 4 is a block diagram illustrating a system according to various embodiments.

FIG. 5 is an example of a user interaction with a computing device configured to vend new printer consumables.

FIG. 6 is a flow diagram depicting steps taken to implement various embodiments.

FIG. 7 is a flow diagram depicting steps taken to implement various embodiments.

The same part numbers designate the same or similar parts throughout the figures.

### DETAILED DESCRIPTION OF EMBODIMENTS

Sometimes when a consumer sets out to make a purchase-in-person of a new printer consumable (sometimes hereinafter referred to as a “new consumable”) to replace an empty or used printer consumable (sometimes hereinafter referred to a “used printer consumable” or “used consumable), the consumer realizes that he/she does not know which model of consumable is needed for his/her printer. The consumer commonly will encounter at a point of sale a multitude of cartridge packages of varying models and suppliers. As printer consumable packaging typically does not include a pictorial representation of the printer or the consumable, knowledge of a printer model number, cartridge model number or other consumable identifier is needed to proceed. Even if the packaging does contain such a pictorial representation, selection of the consumable without the specific model number of the printer or the cartridge may be prone to error.

When the consumer does not have the model number information for the consumable or the printer, the consumer may face several undesirable choices. A first possibility is to guess as to the model number based upon his/her memory. A second option is to contact someone at the location of the printer to try to retrieve model information. A third option is to physically return to the location of the printer, retrieve the model information, and then make a second trip to the retail facility. Such choices can frustrate the consumer and result in a negative printing experience.

Even when the consumer has a model number for the empty consumable and/or the printer, the consumer may still experience difficulty in making a decision between all of the consumable options that are available for his or her printer. Without a detailed knowledge of printing history at the printer or of current consumable levels in the printer, the consumer's decision to purchase may wind up being suboptimal or incomplete. For example, it can be a negative experience for a consumer to make a trip to purchase a replacement black ink consumable, and then find out shortly thereafter that a consumable of another color is approaching empty.

In some instances, the consumer may bring along a used printer consumable to serve as a reference for the purchase of the new consumable. In many instances there will be no responsible, e.g., environmentally friendly, disposal mechanisms available for the consumer at the point of sale. While it is common for manufacturers of printer consumables to provide mail and return envelopes or online information online about returning consumables, the consumer may not be aware of, or in a position to avail him/herself of, such disposal options, and will desire to responsibly dispose of the empty printer consumable at the point of sale.

Accordingly, various embodiments described herein were developed in an effort to facilitate consumer selection of new printer consumables via customized recommendations. Some of the embodiments also facilitate responsible disposal of used consumables. In examples, consumable purchase recommendations are presented to a consumer via a computing device that is configured to vend new printer consumables automatically. As the transaction is automated, the consumer utilizing the device can make informed consumable purchase decisions. Further, in certain examples the recommendation is made in consideration of a used consumable presented to the vending device by a consumer. In certain examples, the consumer can deposit the used consumable into the vending device and the consumable is received for shredding and/or collection in connection with recycling.

As used herein, “vending” refers to selling or offering to sell from a device. As used herein a “printer consumable” refers to an inkjet cartridge, ink cartridge, toner cartridge, printhead, pen, cleaning supply, servicing article or other article that is purchased for use in a printer. “Printer” or “printing device” refers to any electronic device that prints and includes multifunctional electronic devices that perform additional functions such as scanning and/or copying. As used herein, a “network-connected printer” refers to a printer that can be connected to a network, to be capable of obtaining content, sending and receiving messages, accessing network content, and/or accessing applications via a network. In examples, the network may be a proprietary network, a secured network, an open network, an intranet, an extranet, an internet or the Internet. “Content” refers to any text, image, or other content that can be displayed and/or printed. A “new” printer consumable refers to a consumable that has not used in a printer. A “used” consumable refers to a consumable that is not new. To “display” refers to exhibiting or presenting for perception by a user, and includes, but is not limited to visual, auditory and tactile presentations. “Encoded” refers to presented in a format that is generally not readable by a human without the aid of a machine.

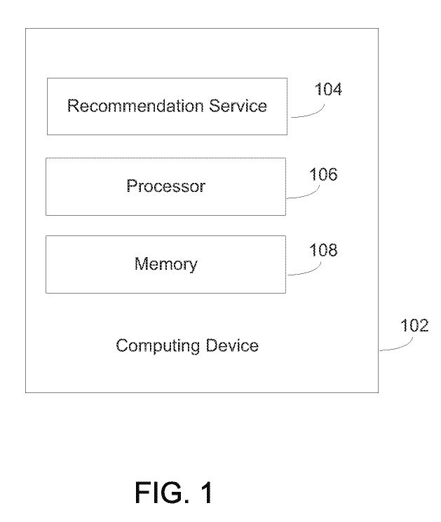

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 1 shows computing device 102, representing generally any computing device or group of computing devices capable of accepting, processing, storing and outputting data according to programmed instructions. In examples, computing device 102 may be or include a server, a desktop computer, a laptop computer, and/or any other type of computing device.

In an example, the computing device 102 is a standalone device configured to vend printer consumables, and is not connected to a network. In another example the computing device 102 is a network-connected device configured to vend printer consumables. In another example the computing device 102 is a server or group of servers that are connected, via a network, to a separate computing device configured to vend printer consumables.

The vending computing devices in the examples described herein may include hardware and programming to enable a user to identify him/herself, to identify a network-connected printer that the user uses, and/or to display consumable recommendations and other messages to a user. The vending computing devices in these examples may additionally include hardware and programming to receive payment from the user, to scan otherwise interpret encoded data regarding a user of the vending device or a used consumable, to collect a used consumable, and/or to dispense a new consumable.

Computing device 102 includes a recommendation service 104. Recommendation service 104 represents generally any combination of hardware and programming configured for use to facilitate user selection of printer consumables via recommendations. In one example, recommendation service 104 receives first data that associates a user of a network-connected computing device configured to vend new printer consumables with a network-connected printer. Examples of network-connected printers are the internet-connected “ePrint” printers available from Hewlett-Packard Company. In other examples, the network-connected printer is a printer connected to an intranet or other private network. It should be noted that while the disclosure is discussed frequently with reference to internet-connected printers, the teachings of the present disclosure are not so limited and can be applied to any network-connected printer.

Recommendation service 104 additionally receives second data regarding printer consumable usage at the printer. Such consumable usage data may include, but is not limited to, a history of types of content printed at the printer and/or a current inventory of levels of ink, toner or other consumables at the printer.

Recommendation service 104 generates a recommendation in consideration of the first data that associates the user of the vending computing device and the second data regarding consumable usage at the printer. The recommendation recommends a new consumable for use at the printer, and is to be displayed at the vending device.

Recommendation service 104 receives third data that payment is received for the new consumable. In an example, the data may be received from the vending device and indicate that a cash or electronic payment (e.g. via a debit or credit card) has been made. In another example, the third data may be received from a payment service or financial institution that processes an electronic payment made by the user.

Having recommended a new consumable to the user at the vending device, and confirmed receipt of payment for the new consumable, recommendation service 104 sends a message authorizing dispensing of the new consumable at the device. If computing device 102 is a vending device, the message may be a message sent to an electro-mechanical apparatus within the vending device that releases the new consumable to a collection bin accessible to the user. If computing device 102 is a device distinct from the vending device, the message may be a message sent from computing device 102 to the vending device to instruct the vending device to dispense or release the new consumable to the user.

The functions and operations described with respect to computer system 102 may be implemented as a computer-readable storage medium containing instructions executed by a processor (e.g., processor 106) and stored in a memory (e.g., memory 108). In a given implementation, processor 106 may represent multiple processors, and memory 108 may represent multiple memories. Processor 106 represents generally any instruction execution system, such as a computer/processor based system or an ASIC (Application Specific Integrated Circuit), a computer, or other system that can fetch or obtain instructions or logic stored in memory 108 and execute the instructions or logic contained therein. Memory 108 represents generally any memory configured to store program instructions and other data.

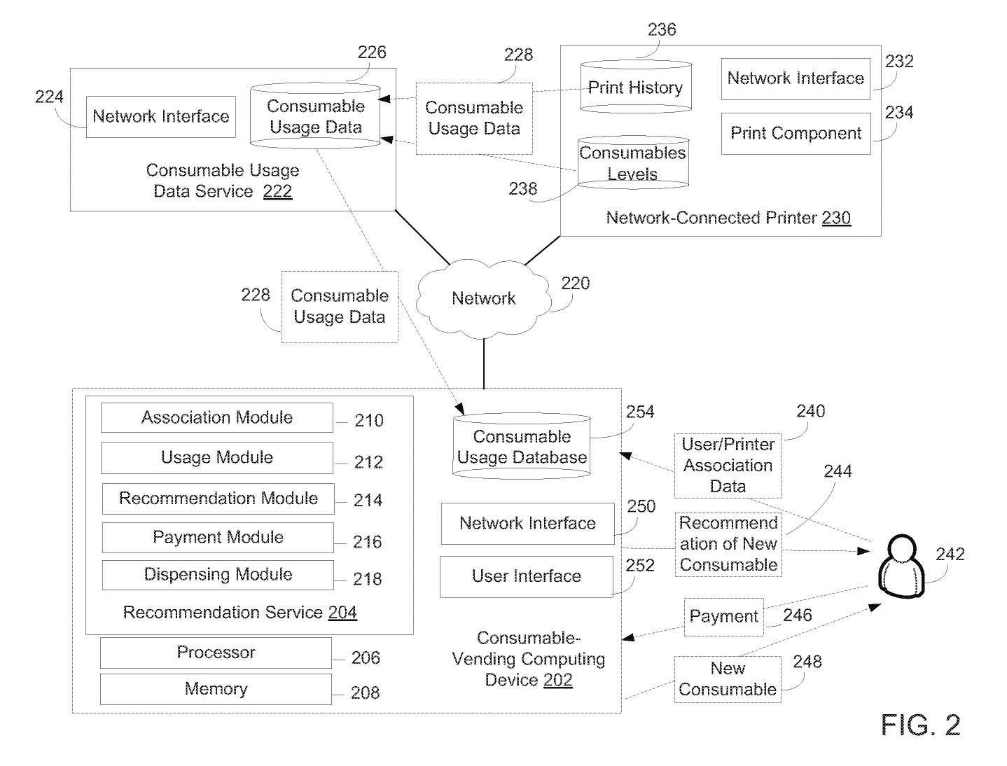

FIG. 2 is a block diagram that includes a consumable-vending computing device according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 2 shows a consumable-vending computing device 202 (hereinafter a “vending device”). Vending device 202 represents generally any computing device or group of computing devices capable of accepting, processing, storing and outputting data according to programmed instructions. Vending device 202 includes a recommendation service 204, representing generally any combination of hardware and programming configured for use to facilitate user selection of printer consumables via recommendations. Recommendation service 204 includes association module 210, usage module 212, recommendation module 214, payment module 216, and dispensing module 218.

Computing device 202 includes a network interface 250 and is connected to a network 220. Network interface 250 represents generally any combination of hardware and programming configured for electronically connecting computing device 202 to network 220. Network 220 may be or include, at least in part, the Internet, an intranet, or a combination of both. Network 220 may also include intermediate proxies, routers, switches, load balancers, and the like.

Also connected to network 220 is a consumable usage data service 222 (hereinafter “usage data service”). Usage data service 222 represents generally any combination of hardware and programming configured for receiving from network-connected printers (e.g., printer 230), storing, and making available to vending device 202, data regarding usage of printer consumables at the network-connected printers. In examples, usage data service 222 may include server, a server system, or any other computing device or system of computing devices. Usage service 222 includes a network interface 224 and a consumable usage data database 226. Network interface 224 represents generally any combination of hardware and programming configured for electronically connecting usage data service 222 to network 220. Consumable usage database 266 stores consumable usage data 228 received from network-connected printer 230, at the direction or with the consent of the user of the printer 230. The consumable usage data 228 may include print history data, consumable levels data, or other consumable usage data. Consumable usage database 266 may also store consumable usage data received from, and relating, to other network-connected printers.

Also connected to network 220 is a printer 230. Network-connected printer 230 represents generally any computing device that is operable to produce printed output and to send and receive communications and content to usage data service 222 and/or other computing devices over the network 220. Printer 230 is shown to include a network interface 232 and a print component 234. Network interface 232 represents generally any combination of hardware and programming configured for electronically connecting printer 230 to network 220. Print component 234 represents generally any combination of hardware and programming configured to produce printed output. Printer 230 stores print history 236 data regarding types of content printed at the printer 230, and data 238 regarding the levels of ink or other consumables at printer 230.

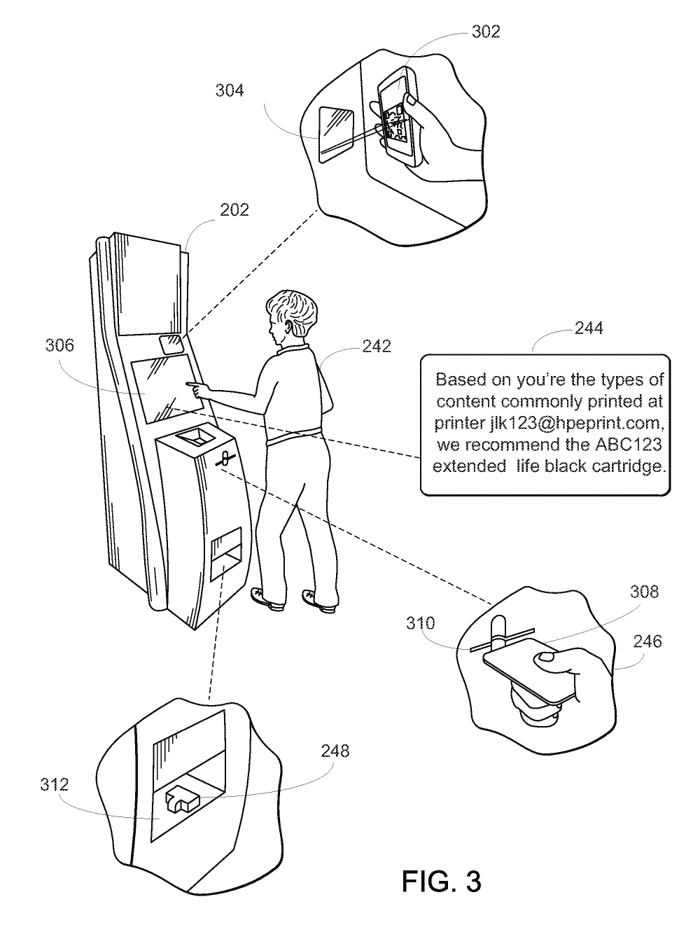

Returning to the recommendation service 204 of vending device 202, association module 210 receives user/printer association data 240 that associates a user 242 of the vending device 202 with the network-connected printer 230. Moving to a pictorial example shown at FIG. 3, the vending device 202 captures the user/printer association data via scanning of an encoded image that the user 226 has presented to the vending device 202 via a smart phone 302 display screen. The scanning takes place utilizing a scanning device 304 that is part of the user interface 252 (FIG. 2) of vending device 202. In examples, the encoded image may be a 1D barcode, 2D barcode, QR code, or any other encoded format. In another example, the user/printer association data 240 may be presented via an electronically encoded card 308 inserted into a card reader device 310 at vending device 202. In another example, the user/printer association data 224 may be presented to vending device 202 by the user 242 via a keyboard or other data entry device that is a part of the user interface 252 of vending device 202.

Returning to FIG. 2, usage module 212 receives, via the network from the usage data service 222 computer system, data 228 regarding consumable usage at network-connected printer 230. Printer 230 is the printer with which the association module 210 associates user 242. The received consumable usage data 228 may include, but is not limited to, a history of types of content printed at the printer and/or a current inventory of levels of ink, toner or other consumables at the printer. In one example, the consumable usage data 228 is requested and received in real-time following the walk-up of user 242 to vending device 242 and the association module's association of user 242 with printer 230. In another example, the consumable usage data is requested and received periodically, and stored at a consumable usage database 254 in anticipation of printer users such as user 242 interacting with vending device 202.

In an example, the receipt of consumable usage data 228 at vending device 202 is the result of pushes of data from the usage data service 222 that occur at regularly scheduled intervals. In another example, consumable usage data 228 is obtained at vending device 202 as the result of pulls of data from usage data service 222 that occur at regularly schedule intervals. In another example, the pulls of data are in response to data requests from the vending device 202 sent via the network 220. The paths between vending device 202, usage data service 222, and printer 230 as depicted in FIG. 2 represent the logical communication paths between these devices, not necessarily the physical paths between the devices. In another example, the vending device 202 may be standalone computing device and receive consumable usage data via periodic downloads from CD, DVD, flash memory, or other portable data storage media.

Recommendation module 214 generates a recommendation in consideration of data 240 that associates the user 242 with printer 230, and in consideration of the data 228 regarding consumable usage at the printer 230. The recommendation module 214 recommends a new printer consumable for use at the printer, the recommendation to be displayed to the user 242 at the vending device 202. Moving to the pictorial example at FIG. 3, the recommendation 244 is presented to the user 242 via a visual display apparatus 306 that is part of the user interface 252 (FIG. 2) at vending device 202. In other examples, the recommendation may be made via an aural or tactile display to user 242. In this example the recommendation is a text message recommending that user 242 purchase an “ABC123 extended life black cartridge”. The recommendation is made in consideration of the data associating user 242 with network-connected printer 230, and the consumable usage data (types of content commonly printed at printer jlk123@hpeprint.com).

Returning to FIG. 2, payment module 216 receives data indicating that payment 246 is received for the recommended new consumable. In an example, the payment-received data may be data received from another component of the vending device 202 and indicate that a cash or electronic payment 246 (e.g. via a debit or credit card) has been made. In another example, the payment-received data may be received from a payment service or financial institution external to vending device 202, the service or institution having processed an electronic payment 246 made by the user 242 via a debit or credit card. Moving to the pictorial example of FIG. 3, payment-received data is received at the payment module 216 (FIG. 2) in response to user 242 making payment 246 for the “ABC123 extended life black cartridge” by inserting a credit or debit card 308 into a card-reading device 310 at vending device 202.

Returning to FIG. 2, dispensing module 218 sends a message authorizing dispensing of the recommended new consumable 248 at the device. Moving to the example of FIG. 3, dispensing module 218 (FIG. 2) sends a message to an electro-mechanical apparatus within the vending device 202. The message causes release of the new consumable 248 from a storage component to a collection bin 312 that is accessible to the user 242 at device 202. User 242 can at this point retrieve the purchased consumable 248.

The functions and operations described with respect to vending device 202 may be implemented as a computer-readable storage medium containing instructions executed by a processor (e.g., processor 206) and stored in a memory (e.g., memory 208).

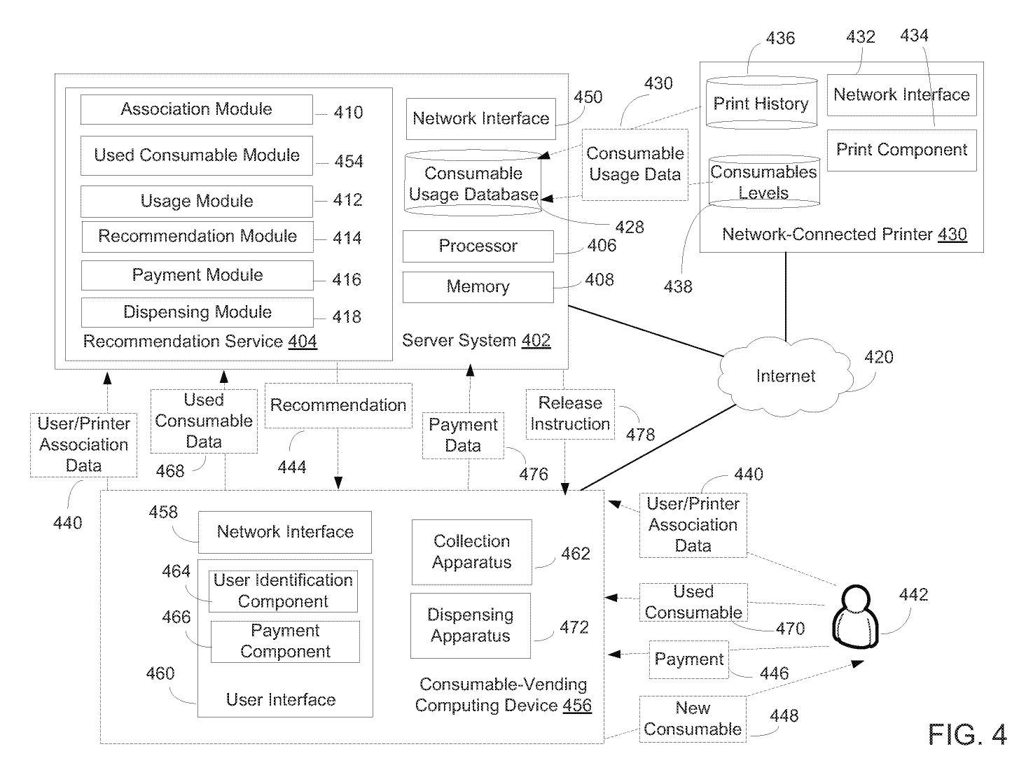

FIG. 4 is a block diagram that includes a server system according to various embodiments. FIG. 4 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 4 shows a server system 402, representing generally any computing device or group of computing devices capable of accepting, processing, storing and outputting data according to programmed instructions. As illustrated in FIG. 4, server system 402 may be a single physical device or it may be distributed among multiple physical devices connected over a network (e.g., the Internet). For example, server system 402 may represent a cloud computing infrastructure (i.e., the cloud). In a cloud computing infrastructure, various components/modules of server system 402 may share resources and/or act in concert even though they might be in different physical locations and/or operating on different physical devices.

Server system 402 includes a recommendation service 404, representing generally any combination of hardware and programming configured for use to facilitate user selection of printer consumables via recommendations. Recommendation service 404 includes association module 410, used consumable module 454, usage module 412, recommendation module 414, payment module 416, and dispensing module 418.

Server system 402 includes a network interface 450 and is connected to an internet 420. Network interface 450 represents generally any combination of hardware and programming configured for electronically connecting server system 402 to internet 420. Internet 420 may be or include, at least in part, the Internet, an intranet, or a combination of both. Internet 420 may also include intermediate proxies, routers, switches, load balancers, and the like.

Also connected to internet 420 is a consumable vending computing device 456. Vending device 456 represents generally any combination of hardware and programming configured to vend a print cartridge, ink cartridge, toner cartridge, or other new printer consumable to a user. In an example, vending device 456 may be in the form of a computerized retail kiosk. Vending device 456 includes a network interface 458, a user interface 460, a collection apparatus 462 and a dispensing apparatus 472. Network interface 458 represents generally any combination of hardware and programming configured for electronically connecting vending computing device 456 to internet 420. User interface 460 includes a user identification component 464 and a payment component 466.

Also connected to internet 420 is a printer 430. Internet-connected printer 430 represents generally any computing device that is operable to produce printed output and to send and receive communications and content to server system 402 and/or other computing devices over the internet 420. Printer 430 is shown to include a network interface 432 and a print component 434. Network interface 432 represents generally any combination of hardware and programming configured for electronically connecting printer 430 to internet 420. Print component 434 represents generally any combination of hardware and programming configured to produce printed output. Printer 430 stores print history 436 data regarding types of content printed at the printer 430, and data 438 regarding the levels of ink or other consumables at the printer 430, for access by the user and for sending to server system 402. The paths between server system 402, vending device 456, and printer 430 as depicted in FIG. 4 represent the logical communication paths between these devices, not necessarily the physical paths between the devices.

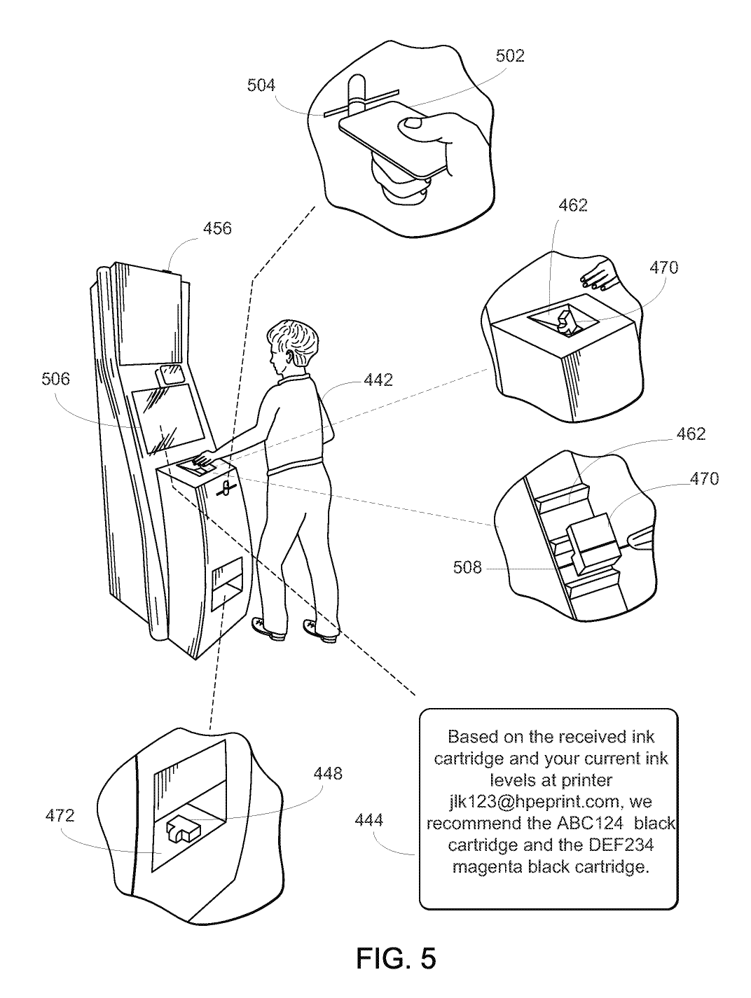

Returning to the recommendation service 404 of server system 402, association module 410 receives from vending device 456 user/printer association data 440 that associates a user 442 of the vending device 456 with the internet-connected printer 430. Moving to a pictorial example shown at FIG. 5, the vending device 456 captures the user/printer association data 440 (FIG. 4) via receipt of electronic identification card 502 presented by user 442 at a card reading device 504 that is part of the user identification component 464 of user interface 460 at vending device 456. In other examples, the user identification component 464 of user interface 460 may incorporate other means of capturing user/printer association data 440 (FIG. 4), e.g., via a keyboard, touchpad, microphone plus voice recognition, or other data entry means.

Returning to FIG. 4, used consumable module 454 receives used consumable data 468 regarding a used printer consumable 470 that is presented by user 442 at the vending device 456. Moving to FIG. 5, in an example the used consumable 470 is presented at vending device 456, and received at the device, by virtue of the user 442 depositing the used consumable 470 into, and the consumable 470 being received within, the collection apparatus 462. In an example, the used consumable data 468 is an identifier of the model and/or type of the used consumable 470 and is received, via pattern recognition of an attribute of the used consumable 470. In an example, the pattern recognition occurs at the collection apparatus 462. In one example, the pattern recognition to identify the model of the used consumable 470 occurs via the collection apparatus recognizing a shape of the used consumable 470 (e.g., a geometry, a number of sides, a measurement of an angle, corner or edge of a cartridge). In another example the attribute that is utilized to identify the model of the used consumable 470 is an encoded image included within the used consumable 470. In an example, the encoded image is in the form of a barcode, a color or grayscale gradient, or other encoding, and is recognized via a scanning apparatus 508 included within collection apparatus 462. In an example, the collection apparatus 462 may hold the presented used consumable 470 to be picked up by a recycling service. In another example, the collection apparatus may cause shredding or other processing of the used consumable 470 at the vending device 456.

In other examples, presentation of the used consumable 470 at the vending device 456 to capture the used consumable data 468 (FIG. 4) may take place via the user 442 holding the used consumable 470 to expose the used consumable 470 to a scanning device that is a part of vending device 456 other than the collection apparatus 462, without a deposit or receipt of the used consumable 470 into collection apparatus 462.

Returning to FIG. 4, usage module 412 receives, via the internet 422 from internet-connected printer 430, data 438 regarding consumable usage at printer 430. Printer 430 is the printer with which the association module 410 associated user 442. The received consumable usage data 428 may include, but is not limited to, a history of types of content printed at the printer and/or a current inventory of levels of ink, toner or other consumables at the printer.

Recommendation module 414 generates a recommendation in consideration of the data 440 that associates the user 442 with printer 430, the data 428 regarding consumable usage at the printer 430, and the data 468 regarding the used consumable 470. The recommendation module 414 recommends a new printer consumable for use at the printer, the recommendation 444 to be displayed to the user 442 at the vending device 456. Moving to the pictorial example at FIG. 5, the recommendation 444 is presented to the user 442 via a display apparatus 506 that is part of the user interface 460 (FIG. 4) at vending device 456. In this example the recommendation is a text message recommends that user 442 purchase an “ABC124 black cartridge and a DEF234 magenta black cartridge.” The recommendation is made in consideration of the tying or association of user 442 to internet-connected printer 430, in consideration of the used consumable data 468, and in consideration of the consumable usage data (current ink levels and types of content commonly printed at printer 430). In example, the recommendation module may additionally send to the vending device 456, for display at the visual display apparatus 506, an offer or a loyalty incentive to user 442 that reduces the price of the new consumable in consideration of the used consumable data 468, the consumable usage data 428, and/or other considerations. In one example, the recommendation module 414 recommends, as at least part of the recommendation 444, a new consumable of the same model as the used consumable 470 presented at the vending device 456.

Returning to FIG. 4, payment module 416 receives data 476 indicating that payment 446 is received for the recommended new consumable. In an example, the payment-received data 476 may be data received from the payment component 466 of vending device 456. In an example, the electronic card 502 that is presented to the vending device 456 to identify user 442 and associate user 442 with printer 430 may also be a card by which payment 446 is made. In an example the electronic card 502 is a prepaid card, from which the purchase price of the new consumable is deducted when user 442 purchases a new consumable.

Returning to FIG. 4, dispensing module 418 sends a message authorizing dispensing of the recommended new consumable 448 at the device. Moving to the example of FIG. 5, dispensing module 418 (FIG. 4) sends a message sent to an electro-mechanical apparatus within the vending device 456, causing release of the new consumable 448 from a storage component to a dispensing apparatus bin 472 that accessible to user 442 at vending device 456. User 442 can at this point retrieve the purchased new consumable 448.

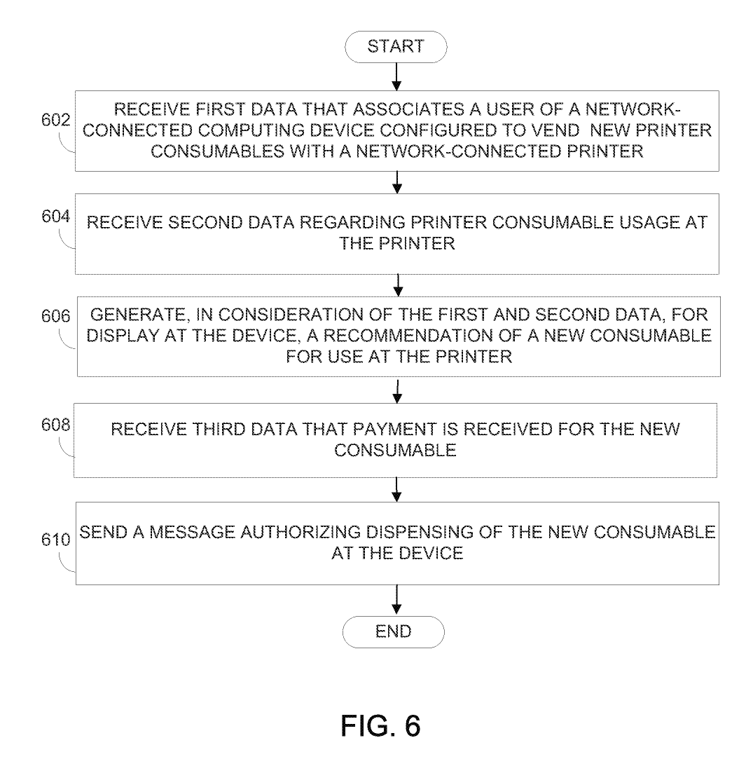

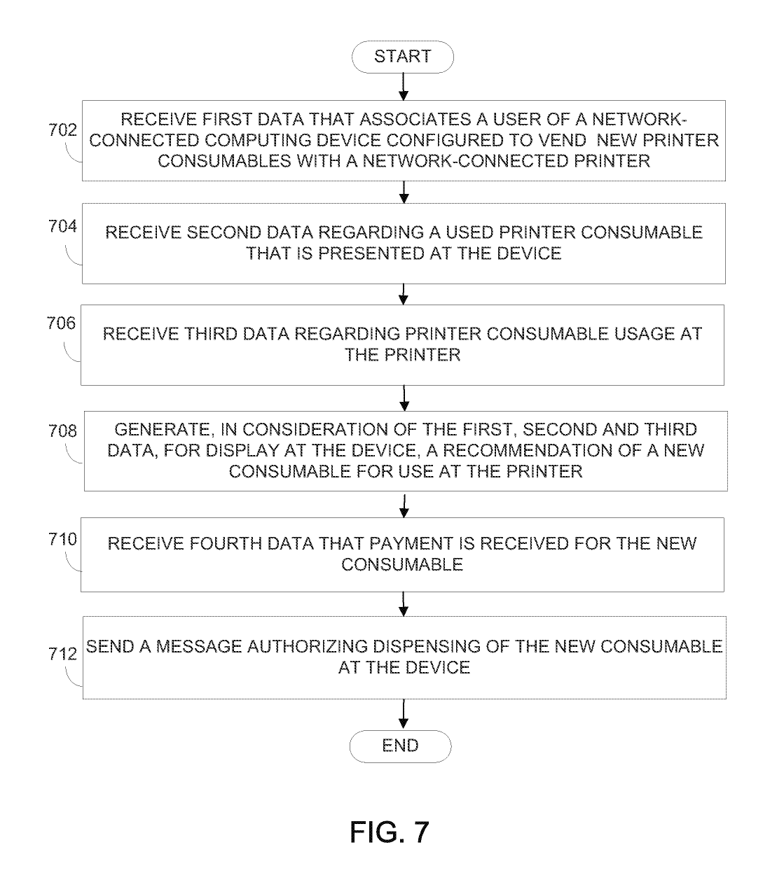

FIGS. 6 and 7 are flow diagrams of operation in a system according to various embodiments. In discussing FIGS. 6 and 7, reference may be made to the diagrams of FIGS. 2 and 4 to provide contextual examples. Implementation, however, is not limited to those examples. Starting with FIG. 6, first data is received. The first data associates a user of a network-connected computing device configured to vend new printer consumables with a network-connected printer. Referring back to FIGS. 2 and 4, the association module 210, 410 may be responsible for implementing block 602.

Continuing with the flow diagram of FIG. 6, second data, regarding printer consumable usage at the printer, is received (block 604). Referring back to FIGS. 2 and 4, the usage module 212, 412 may be responsible for implementing block 604.

Continuing with the flow diagram of FIG. 6, a recommendation of a new consumable for use at the printer is generated. The recommendation is generated in consideration of the first and second data for display at the device (block 606). Referring back to FIGS. 2 and 4, the recommendation module 214, 414 may be responsible for implementing block 606.

Continuing with the flow diagram of FIG. 6, third data is received. The third data that is data indicating that payment for the new consumable is received (block 608). Referring back to FIGS. 2 and 4, the payment module 216, 416 may be responsible for implementing block 608.

Continuing with the flow diagram of FIG. 6, a message is sent that authorizes dispensing of the new consumable at the device (block 610). Referring back to FIGS. 2 and 4, the dispensing module 218, 418 may be responsible for implementing block 610.

Moving to FIG. 7, first data is received. The first data associates a user of a network-connected computing device configured to vend new printer consumables with a network-connected printer. Referring back to FIGS. 2 and 4, the association module 210, 410 may be responsible for implementing block 702.

Continuing with the flow diagram of FIG. 7, second data, regarding a used printer consumable that is presented at the device, is received (block 704). Referring back to FIG. 4, the used consumable module 454 may be responsible for implementing block 704.

Continuing with the flow diagram of FIG. 7, third data, regarding printer consumable usage at the printer, is received (block 706). Referring back to FIGS. 2 and 4, the usage module 212, 412 may be responsible for implementing block 706.

Continuing with the flow diagram of FIG. 7, a recommendation of a new consumable for use at the printer is generated. The recommendation is generated in consideration of the first, second and third data for display at the device (block 708). Referring back to FIGS. 2 and 4, the recommendation module 214, 414 may be responsible for implementing block 708.

Continuing with the flow diagram of FIG. 7, fourth data is received. The fourth data that is data indicating that payment for the new consumable is received (block 710). Referring back to FIGS. 2 and 4, the payment module 214, 416 may be responsible for implementing block 710.

Continuing with the flow diagram of FIG. 7, a message is sent that authorizes dispensing of the new consumable at the device (block 712). Referring back to FIGS. 2 and 4, the dispensing module 218, 418 may be responsible for implementing block 712.

Although the flow diagrams of FIGS. 6 and 7 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

Various modifications may be made to the disclosed embodiments and implementations without departing from their scope. Therefore, the illustrations and examples herein should be construed in an illustrative, and not a restrictive, sense.

What is claimed is:

1. A computer-readable storage medium containing instructions to facilitate selection of printer consumables via recommendations, the instructions when executed by a processor causing the processor to:
receive first data that associates
a user of a network-connected computing device configured to vend new printer consumables
with
a network-connected printer;
receive second data regarding printer consumable usage at the printer;
generate, in consideration of the first and second data, for display at the device, a recommendation of a new consumable for use at the printer;
receive third data that payment is received for the new consumable;
send a message authorizing dispensing of the new consumable at the device.

2. The medium of claim 1,
wherein the second data is received from the printer, and
wherein the instructions further cause sending of the recommendation to the device for display.

3. The medium of claim 1,
wherein the second data is received from a network-connected computer system, and
wherein the instructions further cause displaying of the recommendation at the device.

4. The medium of claim 1, wherein the first data is captured at the device via scanning of an encoded image.

5. The medium of claim 1, wherein the second data regards a printer consumable level at the printer.

6. The medium of claim 1, wherein the second data regards a type of content printed at the printer.

7. The medium of claim 1,
wherein the instructions further cause receiving of fourth data regarding a used printer consumable that is presented at the device; and
wherein the recommendation is generated in consideration of the fourth data.

8. The medium of claim 7, wherein the instructions further cause the used consumable to be received at the device.

9. The medium of claim 7, wherein the fourth data is received via pattern recognition, at the device, of an attribute of the used consumable.

10. The medium of claim 9, wherein the attribute is a shape of the used consumable.

11. The medium of claim 7, wherein the instructions further cause shredding of the used consumable at the device.

12. The medium of claim 7, wherein the instructions further cause sending to the device, for display at the device, an offer of a loyalty incentive.

13. The medium of claim 7, wherein the recommendation recommends a new consumable of the same model as the used consumable.

14. A system to facilitate selection of printer consumables via recommendations, the system comprising:
an association module, configured to receive first data that associates
a user of a network-connected computing device configured to vend new consumables
with
a network-connected printer;
a usage module, configured to receive second data regarding printer consumable usage at the printer;
a recommendation module, configured to generate in consideration of the first and second data, for display at the device, a recommendation of a new printer consumable for use at the printer;
a payment module, configured to receive third data that payment is received for the new consumable; and
a dispensing module, configured to send a message authorizing dispensing of the new consumable at the device.

15. The system of claim 14,
further comprising a used consumable module, configured to receive fourth data regarding a used printer consumable that is presented at the device; and
wherein the recommendation is generated in consideration of the fourth data.
